(19) United States
(12) Patent Application Publication
(10) Pub. No.: US 2010/0089199 A1
(43) Pub. Date: Apr. 15, 2010

(54) TORQUE TRANSFER DEVICE

(75) Inventors: Alois Lafer, Kainbach (AT); Robert Luef, St. Jakob im Walde (AT)

Correspondence Address: HARNESS, DICKEY & PIERCE, P.L.C., P.O. BOX 828, BLOOMFIELD HILLS, MI, 48303, US

(73) Assignee: MAGNA POWERTRAIN AG & CO KG, Lannach (AT)

(21) Appl. No.: 12/577,227

(22) Filed: Oct. 12, 2009

(30) Foreign Application Priority Data
Oct. 13, 2008 (DE) 10 2008 051 450.0

(51) Int. Cl. F16H 37/06; F16D 23/12

(52) U.S. Cl. 74/665 F; 192/93 A

(57) ABSTRACT

A torque transfer device for a motor vehicle has an input element, at least one output element, a friction clutch for the setting of a torque transfer from the input element to the output element and an actuator. The actuator includes a drive motor, a reduction gear unit and a ramp ring mechanism. The ramp ring mechanism has at least one rotatable first actuator ring which is made to convert a rotary movement into an axial actuation of the friction clutch. The reduction gear unit has a worm gear having a worm and a spur gear section meshing with the worm, with the worm being coupled to the drive motor and the spur gear section being coupled to or made in one piece with the rotatable first actuator ring. The axis of rotation of the worm is inclined by an oblique position angle with respect to the rotational plane of the spur gear section, with the oblique position angle substantially corresponding to the pitch angle of the worm. The spur gear section has a straight toothed section.

### CROSS-REFERENCE TO RELATED APPLICATIONS

This application claims the benefit and priority of German Patent Application No. 102008051450.0, filed Oct. 13, 2008. The entire disclosure of the above application is incorporated herein by reference.

### FIELD

The invention relates to a torque transfer device for a motor vehicle. Such a torque transfer device can serve in the powertrain of a motor vehicle having all-wheel drive to transfer a portion of the drive torque provided by a drive unit selectively to a secondary axle. In this case, the torque transfer device can form a transfer case or a hang-on clutch at the rear axle differential transmission. It is furthermore possible, for example, that such a torque transfer device forms a blockable intermediate axle differential transmission of a motor vehicle having all-wheel drive. Different embodiments of such a torque transfer device and different arrangements in the powertrain of a motor vehicle are described in U.S. Pat. No. 7,111,716 B2.

### BACKGROUND

This section provides background information related to the present disclosure which is not necessarily prior art.

A torque transfer device of the named kind has an input element (e.g. input shaft), at least one output element (e.g. output shaft), a friction clutch for the setting of a torque transfer from the input element to the output element and an actuator for the actuation of the friction clutch. This actuator includes at least one drive motor (for example an electric motor), a reduction gear unit and a ramp ring mechanism. The ramp ring mechanism has at least one rotatable first actuator ring which is made to convert a rotary movement into an actual actuation of the friction clutch. The first actuator ring can, for example, have a plurality of ramps or grooves which are distributed along the periphery, which are inclined in the peripheral direction and which cooperate directly or via roller bodies with corresponding ramps or grooves of an associated second actuator ring so that a rotary movement of the first actuator ring relative to the second actuator ring effects an axial movement of the two actuator rings relative to one another.

The named step-down transmission serves for the speed reduction of a rotary movement of the drive motor, which is made, for example, as an electric motor running at high speed, and in this respect to increase the torque provided by the drive motor. It is known for this purpose to make the step-down transmission as a worm gear having a worm and a spur gear section meshing with the worm, wherein the worm is coupled to the output of the drive motor and the spur gear section is coupled to or made in one piece with the named rotatable first actuator ring. The spur gear section can include an angular segment of a spur gear or a spur gear extending over the complete periphery.

A torque transfer device of the named kind is known from DE 20 2005 017 525 U1. The step-down transmission here includes either a bevel gear toothed arrangement in which an obliquely toothed pinion meshes with an obliquely toothed spur gear or a toothed arrangement of a spur gear worm in which an enveloping worm meshes with an obliquely toothed spur gear. The actuator ring forming the spur gear serves as an axially displaceable adjustment ring to actuate a friction clutch. In this respect, the named actuator ring cooperates via a plurality of ball grooves and balls arranged therein with an axially fixed support ring.

DE 100 33 482 A1 describes a torque transfer device having an adjustment plate which cooperates via ball groove configurations with a thrust plate. The adjustment plate has an outer oblique toothed arrangement or a worm toothed arrangement which is in engagement with a rotatingly drivable worm.

### SUMMARY

This section provides a general summary of the disclosure, and is not a comprehensive disclosure of its full scope or all of its features.

It is an object of the invention to provide a torque transfer device of the named kind which permits a precise actuation of the friction clutch and in this respect allows a cost-effective manufacture.

This object is satisfied by a torque transfer device having the features of claim 1 and in particular in that the axis of rotation of the worm is inclined by an oblique position angle with respect to the rotational plane of the spur gear section, with the oblique position angle substantially corresponding to the pitch angle of the worm and with the spur gear section having a straight toothed arrangement.

In the torque transfer device in accordance with the invention, the step-down transmission includes a worm which is driven to make a rotary movement by a drive motor. The axis of rotation of the worm is inclined by an oblique position angle with respect to the rotational plane of a spur gear section with which the gear meshes. The named rotational plane is formed by that plane within which the spur gear section extends and carries out its rotary movement. In other words, it is in this respect the normal plane to the axis of rotation of the spur gear section, with this normal plane containing the spur gear section (and optionally moving axially with it). The named oblique position angle is selected such that it substantially corresponds to the pitch angle of the worm, with the spur gear section meshing with the worm having a straight toothed arrangement. The named oblique position angle can, for example, have a value in the range from 5° to 25°.

The relationship generally applies to the named pitch angle β of the worm:

tan β=P/(d_{T}*π)

Where P is the pitch of the worm, that is the axial extent of a thread pitch (corresponding to a full revolution of the worm). The variable d_{T} designates the diameter of the worm in the pitch circle.

The named angular condition—that is the coincidence of the oblique position angle of the axis of rotation of the worm with the pitch angle of the worm—applies at least in the region of the engagement between the worm and the spur gear section. The spur gear section can hereby move relative to the worm with respect to its axis of rotation in the axial direction without this necessarily being associated with a rotary movement of the spur gear section. Viewed conversely, this means that additional axial forces or tilting moments which are exerted onto the spur gear section due to a rotary movement of the worm are very largely avoided. It is therefore hereby avoided that the axial forces exerted by the actuator onto the friction clutch by means of the ramp ring mechanism are falsified and a more precise actuation of the friction clutch is made possible. In addition, the manufacture of the actuator is simplified since the straight toothed arrangement of the spur gear section can be produced more simply than the oblique toothed arrangement of the spur gear usually provided in the prior art.

It is not necessarily required that the named oblique position angle corresponds exactly to the pitch angle of the gear. A deviation by a few degrees is possible and can even be of advantage for the purpose of an elimination of play. The oblique position angle of the worm only has to correspond to the pitch angle such that an operationally effective engagement of the worm into the straight toothed arrangement of the spur gear section is ensured.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows a schematic view of a powertrain of a motor vehicle;

FIG. 2 shows a schematic view of a transfer case;

FIG. 3 shows a cross-sectional view of a part of a transfer case;

FIG. 4 shows parts of a torque transfer device in a plan view;

FIG. 5 shows a detailed view of a part of the torque transfer device in accordance with FIG. 4.

Corresponding reference numerals indicate corresponding parts throughout the several views of the drawings.

### DETAILED DESCRIPTION

Example embodiments will now be described more fully with reference to the accompanying drawings.

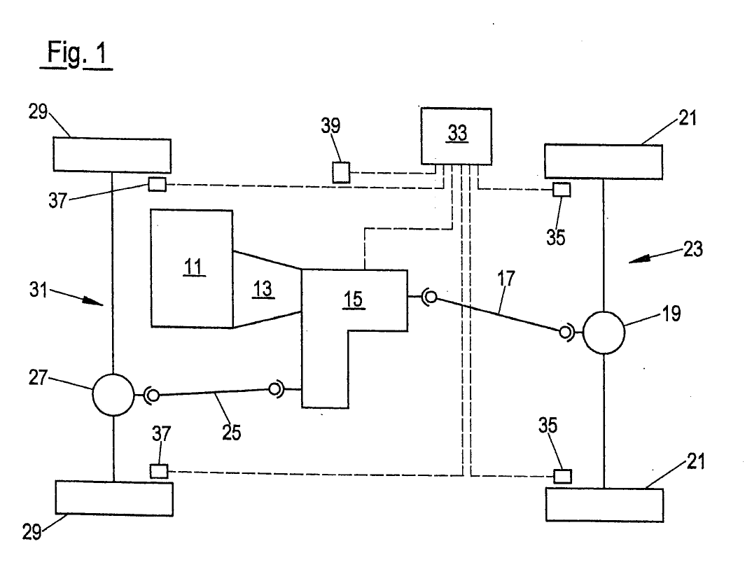

FIG. 1 schematically shows a powertrain of a motor vehicle having an all-wheel drive which can be engaged. The drive torque generated by a combustion engine 11 is supplied via a main transmission 13 (manual shift transmission or automatic transmission) to a transfer case 15. A first output of the transfer case 15 is coupled via a Cardan shaft 17 to a rear axle differential transmission 19. The wheels 21 of the rear axle 23 are hereby permanently driven. The rear axle 23 thus forms the primary axle of the vehicle. A second output of the transfer case 15 is coupled via a Cardan shaft 25 to a front axle differential transmission 27. A portion of the drive torque of the combustion engine 11 can hereby selectively be transferred to the wheels 29 of the front axle 31. The front axle 31 thus forms the secondary axle of the vehicle.

Furthermore, a regulation unit 33 for the driving dynamics is shown in FIG. 1. It is connected to wheel speed sensors 35, 37 which are associated with the wheels 21 of the rear axle 23 or with the wheels 29 of the front axle 31. The regulation unit 33 for the driving dynamics is also still connected to further sensors 39, for example to a yaw rate sensor. Depending on the signals of the sensors 35, 37, 39, the regulation unit 33 for the driving dynamics generates a control signal which is supplied to a control device (not shown in FIG. 1) of the transfer case 15 to hereby set a specific distribution of the drive torque between the two axles 23, 31 of the vehicle. The named control signal is in particular a desired value of a clutch torque, i.e. a torque request for a clutch unit of the transfer case 15.

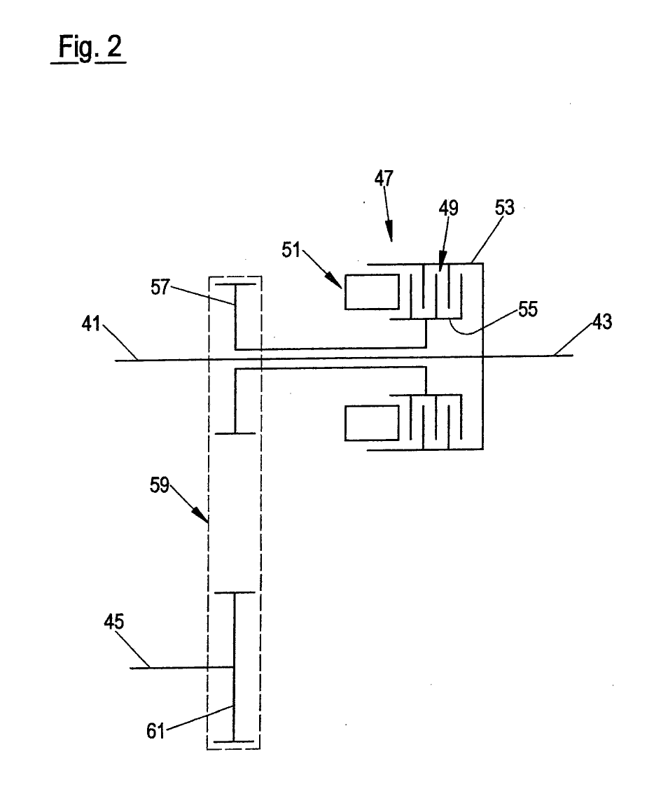

FIG. 2 shows a schematic cross-sectional view of the transfer case 15 in accordance with FIG. 1. The transfer case 15 has an input shaft 41, a first output shaft 43 and a second output shaft 45. The first output shaft 43 is coaxial to the input shaft 41 is made rotationally fixedly—preferably in one piece—therewith. The second output shaft 45 is arranged offset in parallel to the input shaft 41.

The transfer case 15 has a clutch unit 47 having a friction clutch 49 and an actuator 51. The friction clutch 49 has a clutch basket 53 which is rotationally fixedly connected to the input shaft 51 and to the first output shaft 43 and bears a plurality of clutch disks. The friction clutch 49 furthermore has a rotatably journaled clutch hub 55 which likewise bears a plurality of clutch disks which engage in an alternating arrangement into the disks of the clutch basket 53. The clutch hub 55 is rotationally fixedly connected to a drive gear 57 of a chain drive 59. An output gear 61 of the chain drive 59 is rotationally fixedly connected to the second output shaft 45. Instead of the chain drive 59, a gear drive can be provided, for example having an idler gear between the named gears 57, 61.

By actuating the actuator 51 in the engagement sense of the friction clutch 49, an increasing portion of the drive torque introduced into the transfer case 15 via the input shaft 41 can be transferred to the second output shaft 45.

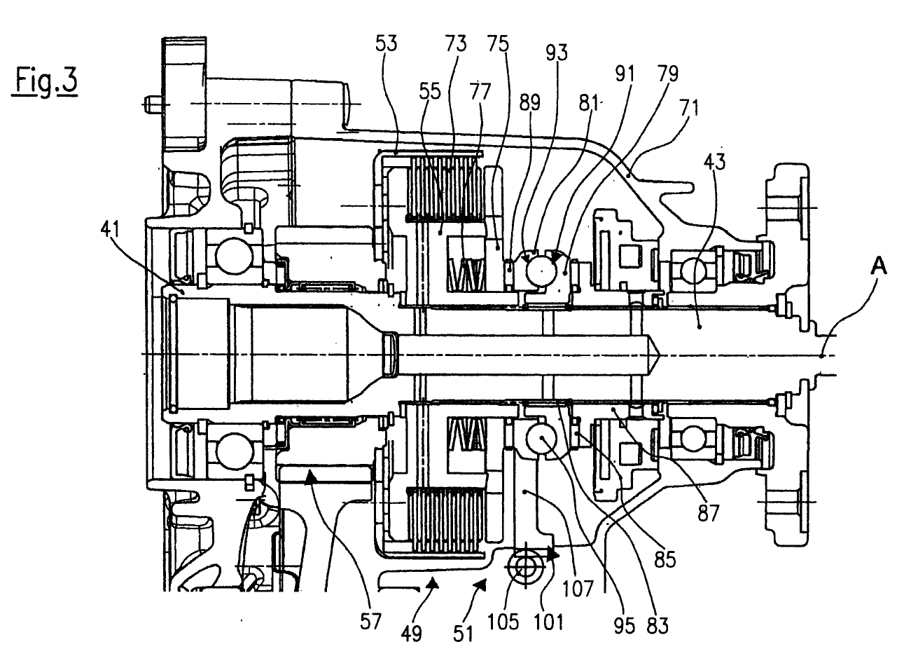

FIG. 3 shows in a cross-sectional view parts of a transfer case in accordance with FIG. 2 in further details. The friction clutch 49 is seated with the clutch basket 53 and the clutch hub 55 inside a housing 71. The clutch hub 55 is rotationally fixedly coupled to the input shaft 41 which is formed in one piece with the first output shaft 43. The clutch hub 55 can be connected by friction locking via the clutch disks 73 to the clutch basket 53 which is rotatably journaled about the axis A of the input shaft 41 or of the friction clutch 49. The clutch basket 53 is coupled via the drive gear 57 (and in this example via an idler gear instead of a chain drive) to the second output shaft (not shown in FIG. 3). The friction locking for the transfer of a torque between the clutch hub 55 and the clutch basket 53 is effected by means of a pressure plate 75 which is axially displaceable against the bias of a plate spring arrangement 77 and hereby presses the respective clutch disks 73 of the clutch hub 55 and of the clutch basket 53 toward one another.

To be able to displace the pressure plate 75 selectively against the bias and to be able hereby to actuate the friction clutch 49, a support ring 79 and an adjustment ring 81 are provided which are arranged coaxially with respect to one another and to the axis A. The adjustment ring 81 forms a rotatable first actuator ring and the support ring 79 forms a rotationally fixed second actuator ring. The support ring 79 is held rotationally fixedly with respect to the housing 71 by means of a fixing device not shown in FIG. 3. In this respect, the support ring 79 is supported by means of a radial bearing 83 and by means of an axial bearing 85 at the input shaft 41 or at a flange section 87 of the input shaft 41. The adjustment ring 81 is rotatably and axially displaceably journaled and it cooperates by means of an axial bearing 89 with the pressure plate 75.

The support ring 79 and the adjustment ring 81 each have a plurality of ball grooves 91 and 93 respectively at the sides facing one another. They extend along a respective peripheral direction with respect to the axis A. A respective ball groove 91 of the support ring 79 and a ball groove 93 of the adjustment ring 81 stand opposite one another and hereby surround a respective ball 95. The ball grooves 91, 93 are inclined with respect to a normal plane of the axis A, i.e. the ball grooves 91, 93 have a varying depth along the named peripheral course. It is hereby achieved that a rotary movement of the adjustment ring 81 relative to the support ring 79 held rotationally fixedly results in an axial displacement of the adjustment ring 81. A rotary movement of the adjustment ring 81 thus has the effect that the pressure plate 75 is axially displaced and the friction clutch 49 is hereby actuated. The bias effected by the plate spring arrangement 77 in this respect ensures that the respective ball 95 remains captured in the associated ball grooves 91, 93 in every rotational position of the adjustment ring 81 relative to the support ring 79.

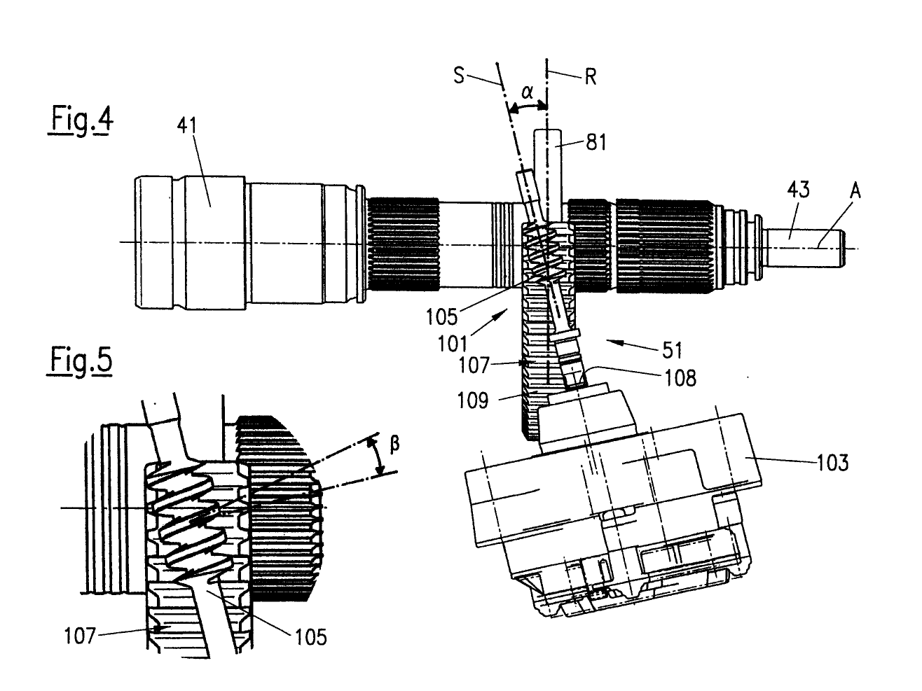

To be able to bring about the explained rotary movement of the adjustment ring 81, it is drive-operationally coupled to an electric motor 103 via a step-down transmission 101. This is shown in the plan view in accordance with FIG. 4.

In accordance with FIG. 4, the reduction gear unit 101 is formed by a worm gear having a worm 105 which meshes with a spur gear section 107. The worm 105 is rotationally fixedly coupled with an output shaft 108 of the electric motor 103. The spur gear section 107 is made in one piece with the adjustment ring 81.

The axis of rotation S of the worm 105 is inclined by an oblique position angle α with respect to the rotational plane R of the spur gear section 107. This oblique position angle α corresponds to the pitch angle β of the worm 105. The pitch angle β of the worm 105 is shown in FIG. 5 which shows a detailed view of the engagement region between the worm 105 and the spur gear section 107. The pitch angle β can be recognized here as the angle which the worm thread adopts relative to a normal plane of the worm axis S.

As can furthermore be seen from FIG. 4, the spur gear section 107 of the adjustment ring 81 has a straight toothed arrangement 109. The spur gear section 107 is made as a peripheral section of a cylindrical spur gear, that is not, for instance, as an enveloping gear. The worm 105 is made as a cylinder worm, with the worm 105 and the spur gear section 107 being in engagement in the manner of a bevel gear toothed arrangement. Alternatively, the worm can, however, also be made as an enveloping worm to mesh with the spur gear section 107 in the manner of a spur gear worm toothed arrangement.

The thread of the worm 105 hereby extends in the engagement region between the worm 105 and the spur gear section 107 substantially parallel to the axis of rotation A of the adjustment ring 81. The adjustment ring 81 can thus move freely, i.e. without a superimposed rotary movement, in the axial direction and the rotary drive of the adjustment ring 81 by means of the worm 105 does not result in any additional axial forces and tilting moments, or only in slight additional axial forces and tilting moments, which act on the adjustment ring 81. A precise control of the actuator 57 and a precise actuation of the friction clutch are hereby possible. This applies in particular if the control of the actuator is based on a monitoring of the motor current of the electric motor 103.

In addition, due to the straight toothed arrangement 109 of the spur gear section 107, the production of the adjustment ring 81 is simplified.

The named spur gear section 107 can naturally also extend along the total periphery of the adjustment ring 81, i.e. in this case the total outer periphery of the adjustment ring 81 is formed by the spur gear section 107.

Whereas the invention was explained above by way of example in connection with a transfer case for a motor vehicle having a permanently driven rear axle 23 and engageable front axle 31, the torque transfer device in accordance with the invention can also be used in other embodiments or arrangements in a powertrain of a motor vehicle, in particular as described in U.S. Pat. No. 7,111,716 B2. The torque transfer device can, for example, be used for a permanent drive of the front axle with an engageable drive of the rear axle or in a blockable intermediate axle differential transmission. It is furthermore possible that the friction clutch 49 is seated on the input shaft 41 or on one of the output shafts 43, 45. In addition, different degrees of freedom of the two actuator rings (support ring 79 and adjustment ring (81) can be provided.

### REFERENCE NUMERAL LIST

11 combustion engine
13 main transmission
15 transfer case
17 Cardan shaft
19 rear axle differential transmission
21 wheel
23 rear axle
25 Cardan shaft
27 front axle differential transmission
29 wheel
31 front axle
33 regulation unit for driving dynamics
35 wheel speed sensor
37 wheel speed sensor
39 sensor
41 input shaft
43 first output shaft
45 second output shaft
47 clutch unit
49 friction clutch
51 actuator
53 clutch basket
55 clutch hub
57 drive toothed wheel
59 chain drive
61 output gear
71 housing
73 clutch disks
75 pressure plate
77 plate spring arrangement
79 support ring
81 adjustment ring
83 radial bearing
85 axial bearing
87 flange section
89 axial bearing
91 ball groove
93 ball groove
95 ball
101 reduction gear unit
103 electric motor
105 worm
107 spur gear section
108 output shaft of the electric motor
109 straight toothed arrangement
A axis
axis of rotation
R plane of rotation
α oblique position angle
β pitch angle

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A torque transfer device for a motor vehicle, comprising:
an input element (41),
at least one output element (43, 45),
a friction clutch (49) for the setting of a torque transfer from the input element to the at least one output element, and having an actuator (51) for the actuation of the friction clutch, wherein the actuator has a drive motor (103),
a reduction gear unit (101) and a ramp ring mechanism, with the ramp ring mechanism having at least one rotatable first actuator ring (81) which is made to convert a rotary movement into an axial actuation of the friction clutch (49), and wherein the reduction gear unit (101) has a worm gear with a worm (105) and a spur gear section (107) meshing with the worm, with the worm (105) being coupled to the drive motor (103) and the spur gear section (107) being coupled to or made in one piece with the rotatable first actuator ring (81), characterized in that
the axis of rotation (S) of the worm (105) is inclined by an oblique position angle (α) with respect to the rotational plane (R) of the spur gear section (107), with the oblique position angle (α) substantially corresponding to the pitch angle (β) of the worm (105), and with the spur gear section (107) having a straight toothed section (109).

2. The torque transfer device in accordance with claim 1, wherein the worm (105) is rotationally fixedly coupled with an output shaft (108) of the drive motor (103) or is made in one piece therewith.

3. The torque transfer device in accordance with claim 1, wherein the worm (105) is made as a cylinder worm.

4. The torque transfer device in accordance with claim 1, wherein the rotatable first actuator ring (81) is axially movably journaled with respect to its axis of rotation (A).

5. The torque transfer device in accordance with claim 1, wherein the torque transfer device furthermore has a rotationally fixed second actuator ring (79), and wherein the rotatable first actuator ring (81) and the rotationally fixed second actuator ring (81) cooperate via a plurality of ramps or grooves (67, 69) extending in an inclined manner in the peripheral direction so that a rotary movement of the first actuator ring (81) relative to the second actuator ring (79) effects an axial movement of the first actuator ring and of the second actuator ring relative to one another.

6. The torque transfer device in accordance with claim 1, wherein the torque transfer device is made as a transfer case (15) for a motor vehicle having all-wheel drive, wherein the input element (41) has an input shaft, with the at least one output element having a first input shaft (43), wherein the torque transfer device furthermore has a second output shaft (45) and wherein the friction clutch (49) is made to transfer a drive torque selectively from the input shaft (41) to the second output shaft (45), or wherein the friction clutch is made to transfer a blocking torque selectively to a differential transmission which couples the input shaft to the two output shafts.
